(19) United States
(12) Patent Application Publication
(10) Pub. No.: US 2022/0019101 A1
(43) Pub. Date: Jan. 20, 2022

(54) LAMINATED GLASS AND PROJECTION IMAGE DISPLAY SYSTEM

(71) Applicant: FUJIFILM Corporation, Tokyo (JP)

(72) Inventors: Tetsu KITAMURA, Minamiashigara-shi (JP); Shusuke ARITA, Minamiashigara-shi (JP); Akio TAMURA, Minamiashigara-shi (JP)

(73) Assignee: FUJIFILM Corporation, Tokyo (JP)

(21) Appl. No.: 17/487,275

(22) Filed: Sep. 28, 2021

Related U.S. Application Data
(63) Continuation of application No. PCT/JP2020/013095, filed on Mar. 24, 2020.

(30) Foreign Application Priority Data
Mar. 29, 2019 (JP) 2019-065973

(51) Int. Cl. G02F 1/13363; G03B 21/00; C09K 19/56; C09K 19/50; C09K 19/36; C09K 19/38

(52) U.S. Cl. CPC G02F 1/13363; G03B 21/006; C09K 19/3838; C09K 19/50; C09K 19/36; C09K 19/56

(57) ABSTRACT

The present invention is to provide a laminated glass having excellent impact resistance and a projection image display system. The laminated glass of the present invention includes a first glass plate, an alignment film containing a vinyl alcohol resin, a retardation layer formed of a composition containing a polymerizable liquid crystal compound and a compound represented by Formula (1), a cholesteric liquid crystal layer, and a second glass plate in this order.

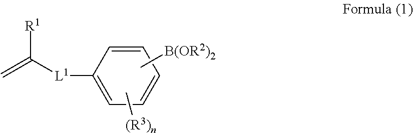

### CROSS-REFERENCE TO RELATED APPLICATIONS

This application is a Continuation of PCI International Application No. PCT/JP2020/013095 filed on Mar. 24, 2020, which claims priority under 35 U.S.C. § 119(a) to Japanese Patent Application No. 2019-065973 filed on Mar. 29, 2019. The above application is hereby expressly incorporated by reference, in its entirety, into the present application.

### BACKGROUND OF THE INVENTION

### 1. Field of the Invention

The present invention relates to a laminated glass and a projection image display system.

### 2. Description of the Related Art

A laminated glass used for an automobile windshield or the like includes a half-mirror film, so that the laminated glass can also be used as a projection image display member of a head-up display system (HUD system).

It is disclosed in WO2016/052367A that a laminated glass containing a retardation layer and a plurality of cholesteric liquid crystal layers between two glass plates.

### SUMMARY OF THE INVENTION

The present inventors have studied the characteristics of the laminated glass described in WO2016/052367A, and found that there was room for improvement in impact resistance.

An object of the present invention is to provide a laminated glass having excellent impact resistance in view of the above circumstances.

Another object of the present invention is also to provide a projection image display system.

As a result of diligent studies on the above objects, the present inventors have found that the above objects can be achieved by the following configurations.

(1) A laminated glass comprising, in the following order:

a first glass plate;

an alignment film containing a vinyl alcohol resin;

a retardation layer formed of a composition containing a polymerizable liquid crystal compound and a compound represented by Formula (1) described later;

a cholesteric liquid crystal layer; and

a second glass plate.

(2) The laminated glass according to (1), in which the compound represented by Formula (1) is a compound represented by Formula (2).

(3) The laminated glass according to (2), in which L² represents a single bond or a divalent linking group selected from the group consisting of —O—, —CO—, —S—, an alkylene group, and a combination thereof, and R represents a hydrogen atom or an alkyl group.

(4) The laminated glass according to any one of (1) to (3), in which the compound represented by Formula (l) is a compound represented by Formula (3).

(5) The laminated glass according to any one of (1) to (4), in which the compound has a molecular weight of 200 or more and less than 350.

(6) The laminated glass according to any one of (1) to (5), in which a content of the compound in the composition is 0.30 to 6.0 parts by mass with respect to 100 parts by mass of the polymerizable liquid crystal compound.

(7) A projection image display system comprising:

the laminated glass according to any one of (1) to (6); and

a projector.

According to the present invention, it is possible to provide the laminated glass having excellent impact resistance.

In addition, according to the present invention, it is possible to provide a projection image display system.

### BRIEF DESCRIPTION OF THE DRAWINGS

FIG. 1 is a conceptual diagram of an example of a laminated glass according to an aspect of the present invention.

FIG. 2 is a schematic diagram for explaining a projection image display system including a laminated glass.

### DESCRIPTION OF THE PREFERRED EMBODIMENTS

Hereinafter, the present invention will be described in detail.

In the present specification, the numerical range represented by using “to” means a range including numerical values described before and after “to” as a lower limit value and an upper limit value.

In the present specification, in a case where the term “selective” is used regarding circular polarization, light amount of any one of a dextrorotatory circularly polarized light component or a levorotatory circularly polarized light component of light is greater than light amount of the other circularly polarized light component. Specifically, in the case where the term “selective” is used, a circular polarization degree of light is preferably 0.3 or more, more preferably 0.6 or more, even more preferably 0.8 or more, and particularly preferably substantially 1.0. Here, in a case where the intensity of a dextrorotatory circularly polarized light component of light is denoted by I_{R} and the intensity of a levorotatory circularly polarized light component of light is denoted by I_{L}, a circular polarization degree is a value represented by |I_{R}−I_{L}|/(I_{R}+I_{L}).

In the present specification, the term “sense” is used regarding circular polarization means either dextrorotatory circularly polarized light or levorotatory circularly polarized light. Regarding the sense of the circular polarization, in a case where light travels toward an observer and the traveling light is being observed by the observer, dextrorotatory circularly polarized light is defined as a case where the tip of the electric field vector rotates in the clockwise direction as the time increases, whereas levorotatory circularly polarized light is defined as a case in which the tip rotates in the counterclockwise direction.

In the present specification, the term “sense” may be used in regards to a twisted direction of a helix of a cholesteric liquid crystal. In a case where a twisted direction (sense) of a helix of a cholesteric liquid crystal is the right direction, the cholesteric liquid crystal reflects dextrorotatory circularly polarized light and transmits levorotatory circularly polarized light, and in a case where the sense is the left direction, the cholesteric liquid crystal reflects levorotatory circularly polarized light and transmits dextrorotatory circularly polarized light.

In the present specification, the term “light” means light of visible light and natural light (non-polarized light), unless otherwise noted. The visible light is light at a wavelength visible to the human eyes among electromagnetic waves, and is normally light in a wavelength range of 380 to 780 nm.

In the present specification, in a case of simply using the term “reflected light” or “transmitted light”, the terms are used as meanings to include scattered light and diffracted light, respectively.

A polarization state of light at each wavelength can be measured with a spectral radiance meter or a spectrometer on which a circular polarization plate is mounted. In this case, the intensity of light measured through a dextrorotatory circular polarization plate corresponds to I_{R}, and the intensity of light measured through a levorotatory circular polarization plate corresponds to I_{L}. The polarization state of light at each wavelength can also be measured such that a circular polarization plate is attached to an illuminometer or an optical spectrum meter. The dextrorotatory circular polarization amount is measured by a dextrorotatory circular polarization transmission plate attached, the levorotatory circular polarization amount is measured by a levorotatory circular polarization transmission plate attached, so that a ratio therebetween can be measured.

In the present specification, p-polarized light means polarized light that vibrates in a direction parallel to a light incident surface. The incident surface means a surface that is perpendicular to a reflecting surface and includes incident light and reflected light. A vibrating surface of an electric field vector of the p-polarized light is parallel to the incident surface.

In the present specification, the front retardation (in-plane retardation) is a value measured with AxoScan manufactured by Axometrics, Inc. The measurement wavelength is 550 nm unless otherwise specified.

in the present specification, the term “projection image” means an image that is not a scenery viewed from the driver's position such as the driver's field and is based on a projection of light from a projector to be used. The projection image is observed as a virtual image that is observed by an observer in a case where the projection image is floated over the projection image display portion of a laminated glass.

In the present specification, the term “visible light transmittance” is a visible light transmittance of an A light source defined in JIS R 3212: 2015 (Test methods of safety glazing materials for road vehicles). That is, the transmittance is obtained by measuring a transmittance of each wavelength in a range of 380 to 780 nm with a spectrophotometer using the A light source, multiplying a wavelength distribution of International Commission on Illumination (CIE) photopic spectral luminous efficiency function and pre-calculated weighting functions obtained from an interval wavelength by the transmittance at each wavelength, and performing a weighted average.

A bonding direction of a divalent group (for example, —O—CO—) described in the present specification is not particularly limited, and for example, in the group represented by X-L-Y, in a case where L is —O—CO—, a bonding position at an X side is *1, and a bonding position at a Y side is *2, L may be *1-O—CO-*2, or may be *1-CO—O-*2.

As a feature point of the laminated glass according to an embodiment of the present invention, as will be described later, a retardation layer formed by using a composition that contains a predetermined compound containing a boron atom (a compound represented by Formula (1)) can be mentioned. As a result of studying the problems in the related art, the present inventors have found that since the adhesiveness between an alignment layer and a retardation layer in the laminated glass is weak, as a result, the impact resistance of the laminated glass itself is inferior. Therefore, the present inventors have found that the adhesiveness between the alignment layer and the retardation layer is improved by the compound represented by Formula (1) being used, and as a result, the impact resistance is also improved. The group containing a boron atom of the compound represented by Formula (1) interacts with a polyvinyl alcohol resin in the alignment layer to contribute to the improvement of the adhesiveness between the alignment layer and the retardation layer.

The present inventors have found that an interaction with a polymerizable liquid crystal compound is suppressed by a structure in the compound represented by Formula (1) being controlled, and as a result, the alignment deterioration of the polymerizable liquid crystal compound is suppressed, and high reflection brightness (that is, less haze) can also be achieved.

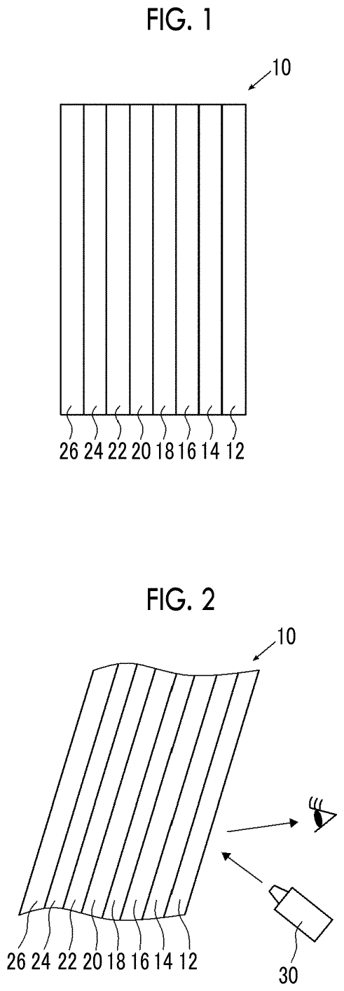

FIG. 1 is a diagram conceptually showing an example of a laminated glass according to an embodiment of the present invention.

A laminated glass 10 shown in FIG. 1 includes a first glass plate 12, a heat seal layer 14, a transparent support 16, an alignment film 18, a retardation layer 20, a cholesteric liquid crystal layer 22, an intermediate film 24, and a second glass plate 26.

The heat seal layer 14, the transparent support 16, and the intermediate film 24 are optional members and may not be included in the laminated glass.

The laminated glass 10 of the present invention is used in, for example, a projection image display system according to an embodiment of the present invention. More specifically, as conceptually shown in FIG. 2, a user observes a virtual image of a projection image by a projector 30 projected by the projector 30 and reflected by the cholesteric liquid crystal layer 22 in the laminated glass 10.

As shown in FIG. 2, in the laminated glass 10, the first glass plate 12 is disposed at a position closer to a visible side, and the second glass plate 26 is disposed at a position farther from the visible side.

Hereinafter, each member constituting the laminated glass 10 will be described in detail.

<First Glass Plate and Second Glass Plate>

The laminated glass according to the embodiment of the present invention includes a first glass plate and a second glass plate.

Examples of the glass plate capable of forming the first glass plate and the second glass plate include a glass plate generally used for laminated glass.

Examples of the glass plate include a glass plate having a visible light transmittance of 80% or less, such as a green glass having high heat shielding properties.

The laminated glass according to the embodiment of the present invention is preferably formed with two glass plates (first glass plate and second glass plate) that have gently curved surfaces, and is more preferably formed with the first glass plate and the second glass plate that have concave gently curved surfaces on the visible side.

Thicknesses of the first glass plate and the second glass plate are not particularly limited, and each thickness may be approximately 0.5 to 5.0 mm and is preferably 1.0 to 3.0 mm.

Materials and thicknesses of the first glass plate and the second glass plate may be the same or different from each other.

<Heat Seal Layer>

The laminated glass according to the embodiment of the present invention may have a heat seal layer. As described above, the heat seal layer is an optional member.

The heat seal layer is a layer for physically bonding the first glass plate and a transparent support described later, a thermoplastic resin included in the heat seal layer functions to fuse by heating during the production of the laminated glass.

The heat seal layer contains a thermoplastic resin. The thermoplastic resin is preferably an amorphous resin. In addition, the thermoplastic resin is preferably a synthetic resin.

As the thermoplastic resin, a resin having excellent affinity and adhesiveness to the glass plate is preferable, and examples thereof include resins selected from the group consisting of a polyvinyl acetal resin (polyvinyl butyral (PVB) resin), an ethylene-vinyl acetate copolymer, and a chlorine containing resin.

The thermoplastic resin is preferably used as a main component of the heat seal layer. The main component means a component occupying a ratio of 50% by mass or more with respect to the total mass of the heat seal layer.

As the thermoplastic resin, polyvinyl butyral or an ethylene-vinyl acetate copolymer is preferable, and polyvinyl butyral is more preferable.

Polyvinyl butyral can be obtained by acetalizing polyvinyl alcohol with butyl aldehyde. The degree of acetalization of polyvinyl butyral is preferably 40% to 85%, and more preferably 60% to 75%.

The heat seal layer may contain inorganic fine particles.

As the inorganic fine particles, inorganic oxide fine particles are preferable. As a component constituting the inorganic oxide fine particles, silica (silicon dioxide), aluminum oxide, titanium dioxide, or zirconium oxide is preferable, and silica is more preferable.

The inorganic fine particles preferably consist of primary particles and form a secondary particle obtained by aggregation of the primary particles.

An average secondary particle diameter of the inorganic fine particles is preferably 100 to 500 nm, and more preferably 150 to 400 nm. The average secondary particle diameter described above is a value measured by the fitting of a perfectly spherical shape (refractive index of 1.46) using a laser diffraction scattering particle diameter distribution measurement device. As a measurement device, MicroTrac MT3000 manufactured by MicrotracBEL Corp. is used.

A content of the inorganic fine particles is preferably 1% to 40% by mass and more preferably 3% to 30% by mass with respect to the total mass of the heat seal layer.

A thickness of the heat seal layer is not particularly limited, but is preferably 0.1 to 50 μm, more preferably 0.1 to 25 μm and even more preferably 0.1 to 10 μm.

<Transparent Support>

The laminated glass according to the embodiment of the present invention may include a transparent support. As described above, the transparent support is an optional member.

The total light transmittance of the transparent support is preferably 80% or more, and more preferably 90% or more. The upper limit is not particularly limited, but may be less than 100%.

In-plane retardation of the transparent support is preferably 10 nm or less, and more preferably 5 nm or less. The absolute value of a thickness direction retardation Rth of the transparent support is preferably 40 nm or less, and more preferably 30 nm or less.

Since the in-plane retardation and the thickness direction retardation are small, the disturbance of polarized light due to the transparent support is reduced.

The material for forming the transparent support is not particularly limited, a resin is preferable, a cellulose acylate resin or an acrylic resin is more preferable, a cellulose acylate resin is even more preferable, and a triacetyl cellulose resin or a diacetyl cellulose resin is particularly preferable.

A thickness of the transparent support is not particularly limited, but is preferably 5.0 to 1000 μm, more preferably 10 to 250 μm, and even more preferably 15 to 90 μm.

<Alignment Film>

The laminated glass according to the embodiment of the present invention includes an alignment film. The alignment film is a layer used for forming a retardation layer described later, and is a layer having an alignment restriction force.

The alignment film contains a polyvinyl alcohol resin. The polyvinyl alcohol resin interacts with a boron-containing group in a compound represented by Formula (1) described later to contribute to the prevention of peeling between the alignment film and the retardation layer, and as a result, the impact resistance of the laminated glass is improved.

The polyvinyl alcohol resin is a resin containing a repeating unit of —CH₂—CHOH—, and examples thereof include polyvinyl alcohol and an ethylene-vinyl alcohol copolymer.

The polyvinyl alcohol resin can be obtained by, for example, saponification of a polyvinyl acetate resin. Examples of the polyvinyl acetate resin include polyvinyl acetate, which is a homopolymer of vinyl acetate, and a copolymer of vinyl acetate and other monomers copolymerizable with the vinyl acetate.

Examples of other monomers copolymerizable with vinyl acetate include unsaturated carboxylic acids, olefins, vinyl ethers, unsaturated sulfonic acids, and acrylamides having an ammonium group.

At least one hydroxyl group of the polyvinyl alcohol resin may be modified with a functional group such as an acetoacetyl group, a sulfonic acid group, a carboxyl group, and an oxyalkylene group. That is, the polyvinyl alcohol resin may be a so-called modified polyvinyl alcohol resin.

Examples of the modified polyvinyl alcohol resin include a polyvinyl alcohol resin containing a polymerizable group (for example, a (meth)acryloyl group and a vinyl group).

Therefore, the polyvinyl alcohol resin includes an unmodified polyvinyl alcohol resin and a modified polyvinyl alcohol resin.

A content of the polyvinyl alcohol resin in the alignment film is not particularly limited, but the polyvinyl alcohol resin is preferably contained as a main component in the alignment film. The main component means that the content of the polyvinyl alcohol resin is 50% by mass or more with respect to the total mass of the alignment film. The content of the polyvinyl alcohol resin is preferably 90% by mass or more with respect to the total mass of the alignment film. The upper limit is not particularly limited, but is 99.9% by mass or less in many cases.

A thickness of the alignment film is not particularly limited, but is preferably 0.01 to 5.0 μm, and more preferably 0.05 to 2.0 μm.

As a specific procedure for forming the alignment film, a method in which a composition for forming an alignment film containing a poly vinyl alcohol resin and a solvent is applied to form a coating film, and the coating film is subjected to a rubbing treatment to form an alignment film is mentioned.

Examples of an object to which the composition for forming an alignment film is applied include the transparent support described above.

A method of applying the composition for forming an alignment film is not particularly limited, and examples thereof include a wire bar coating method, an extrusion coating method, a direct gravure coating method, a reverse gravure coating method, and a die coating method.

After the composition for forming an alignment film is applied onto the support, the support to which the composition for forming an alignment film is applied may be subjected to a drying treatment to remove the solvent, as necessary.

Next, the coating film obtained by the above procedure is subjected to a rubbing treatment to form an alignment film.

A method of a rubbing treatment is not particularly limited, and a known method is adopted.

<Retardation Layer>

The laminated glass according to the embodiment of the present invention includes a retardation layer.

The retardation layer is used in combination with the cholesteric liquid crystal layer, so that a projection image can be clearly displayed. The front retardation and the slow axial direction are adjusted to give high brightness in a HUD system and a double image can be prevented.

The retardation layer is usually provided on the visible side with respect to all the cholesteric liquid crystal layers in a case of being used.

The retardation layer is formed of a composition containing a polymerizable liquid crystal compound and a compound represented by Formula (1).

In the following, first, components contained in the composition will be described in detail.

(Polymerizable Liquid Crystal Compound)

The polymerizable liquid crystal compound is a liquid crystal compound containing a polymerizable group.

The polymerizable liquid crystal compound may be a rod-shaped liquid crystal compound or a disk-shaped liquid crystal compound, and a rod-shaped liquid crystal compound is preferable.

Examples of the rod-shaped polymerizable liquid crystal compound include a rod-shaped nematic liquid crystal compound. Examples of the rod-shaped nematic liquid crystal compound preferably include azomethine compounds, azoxy compounds, cyanobiphenyl compounds, cyanophenyl ester compounds, benzoate compounds, phenylester cyclohexanecarboxylate compounds, cyanophenylcyclohexane compounds, cyano-substituted phenylpyrimidine compounds, alkoxy-substituted phenylpyrimidine compounds, phenyldioxane compounds, tolane compounds, or alkenylcyclohexylbenzonitrile compounds.

Not only a low-molecular liquid crystal compound, but also a polymer liquid crystal compound can be used.

The polymerizable liquid crystal compound can be obtained by introducing a polymerizable group into the liquid crystal compound.

Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods.

The number of polymerizable groups contained in the polymerizable liquid crystal compound is preferably 1 to 6 and more preferably 1 to 3 per molecule.

Examples of the polymerizable liquid crystal compound include compounds disclosed in Makromol. Chem., vol. 190, pp. 2255 (1989), Advanced Materials, vol. 5, pp. 107 (1993), U.S. Pat. Nos. 4,683,327A, 5,622,648A, 5,770,107A, WO95/022586A, WO95/024455A, WO97/00600A, WO98/23580A, WO98/52905, JP1989-272551A (JP-H01-272551A), JP 1994-016616A (JP-H06-016616A), JP 1995-110469A (JP-H07-110469A), JP1999-080081A (JP-H11-080081A), JP2001-328973A, and the like.

In the composition, two or more kinds of the polymerizable liquid crystal compounds may be used in combination.

The content of the polymerizable liquid crystal compound in the composition is preferably 80% to 99.9% by mass, more preferably 85% to 99.5% by mass with respect to the mass of solid contents in the composition (the mass excluding the solvent).

(Compound Represented by Formula (1))

The composition contains a compound represented by Formula (1).

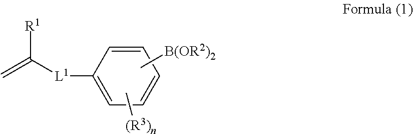

In Formula (1), R¹ represents a hydrogen atom or a methyl group. Among these, a hydrogen atom is preferable from the viewpoint that the laminated glass has more excellent impact resistance (hereinafter, also simply referred to as “the viewpoint that the effect of the present invention is more excellent”).

L¹ represents a single bond or a divalent linking group. A kind of the divalent linking group is not particularly limited, and examples thereof include a divalent linking group selected from the group consisting of —O—, —CO—, —NR⁴—, —S—, an alkylene group, an arylene group, a heterocyclic group, and a combination thereof.

The number of carbon atoms in the alkylene group is not particularly limited, and 1 to 10 is preferable and 1 to 5 is more preferable.

The number of carbon atoms in the arylene group is not particularly limited, and 4 to 20 is preferable and 6 to 12 is more preferable.

The heterocyclic group is a group derived from a ring containing a hetero atom, and examples of a heterocyclic ring include an aromatic heterocyclic ring and an aliphatic heterocyclic ring.

The above combination is a group formed by two or more kinds of groups being combined with each other, and examples thereof include a —CO—O-alkylene group-, —CO—O-alkylene group-NR⁴—CO—O—, —CO—O-alkylene group-O—, —CO—O-alkylene group-O-arylene group-CO—O—, —CO—NR⁴—, alkylene group-NR⁴—CO—O—, -alkylene group-O—, and -alkylene group-O-arylene group-CO—O—.

R⁴ represents a hydrogen atom or an alkyl group. The number of carbon atoms in the alkyl group is not particularly limited, preferably 1 to 3, and more preferably 1.

The alkylene group, arylene group, and heterocyclic group may be substituted with a substituent. Examples of the substituents include the groups exemplified in the following substituent group W.

Substituent group W: a halogen atom, an alkyl group, an alkenyl group, an alkynyl group, an aryl group, a heteroaryl group, a cyano group, a hydroxyl group, a carboxyl group, a nitro group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an amino group), an ammonio group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclicthio group, a sulfamoyl group, an alkyl or arylsulfinyl group, an alkyl or arylsulfonyl group, an acyl group, an aryloxycarbonyl group, an alkoxycarbonyl group, a carbamoyl group, an aryl or heterocyclicazo group, an imide group, a phosphine group, a phosphinyl group, a phosphinyloxy group, a phosphinylamino group, a phosphono group, a silyl group, and a group combining these.

R² represents a hydrogen atom, a substituted or unsubstituted alkyl group, a substituted or unsubstituted aryl group, or a substituted or unsubstituted heteroaryl group. Among these, a hydrogen atom or a substituted or unsubstituted alkyl group is preferable, and a hydrogen atom is more preferable from the viewpoint that the effect of the present invention is more excellent.

The number of carbon atoms in the alkyl group is not particularly limited, preferably 1 to 10, and more preferably 1 to 5. Examples of the alkyl group include a methyl group, an ethyl group, and a propyl group.

The number of carbon atoms in the aryl group is not particularly limited, preferably 4 to 20, and more preferably 6 to 12. Examples of the aryl group include a phenyl group.

The number of carbon atoms in the heteroaryl group is not particularly limited, preferably 3 to 10, and more preferably 3 to 5. Examples of a hetero atom contained in the heteroaryl group include an oxygen atom, a nitrogen atom, and a sulfur atom.

The alkyl group, aryl group, and heteroaryl group may be substituted with a substituent. Examples of the substituent include the groups exemplified in the above described Substituent group W.

Two R²'s may be bonded to each other to form a ring. Examples of the formed ring include an aliphatic hydrocarbon ring containing a boron atom.

R³ represents a substituent. Examples of the substituent include the groups exemplified in the above described Substituent group W. As the substituent, an alkyl group, a halogen atom, an alkoxy group, or an aryl group is preferable.

n represents an integer of 0 to 4. Among these, 0 or 1 is preferable and 0 is more preferable from the viewpoint that the effect of the present invention is more excellent.

In the compound represented by Formula (1), a position of a group represented by —B(OR²)₂ is not particularly limited, but a meta-coordination arrangement with respect to a bonding position of L¹ is preferable, from the viewpoint that the effect of the present invention is more excellent. That is, the compound represented by Formula (1) is preferably a compound represented by Formula (A).

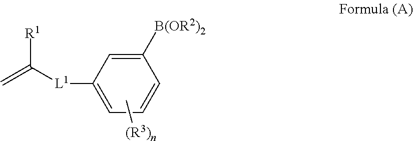

As the compound represented by Formula (1), a compound represented by Formula (2) is preferable.

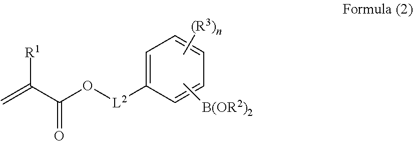

In Formula (2), R¹, R², and R³ are the same as R¹, R², and R³ in Formula (1), respectively.

L² represents a single bond or a divalent linking group selected from the group consisting of —O—, —CO—, —S—, an alkylene group, an arylene group, a heterocyclic group, and a combination thereof.

Suitable aspects of the alkylene group, arylene group, and heterocyclic group are the same as suitable aspects of groups described in L¹, , respectively. Examples of the suitable aspect of the combination of each group represented by L² (the above described combination thereof) include -alkylene group-NR⁴—CO—O—, -alkylene group-O—, and, -alkylene group-O-arylene group-CO—O—.

Among these, L² is preferably a single bond or a divalent linking group selected from the group consisting of —O—, —CO—, —S—, an alkylene group, and a combination thereof from the viewpoint that the effect of the present invention is more excellent.

R⁴ represents a hydrogen atom or an alkyl group.

As the compound represented by Formula (1), a compound represented by Formula (3) is more preferable.

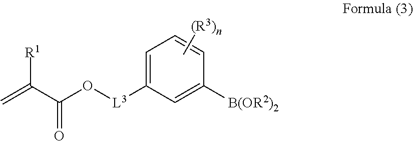

In Formula (3), definitions of R¹, R², and R³ are the same as definitions of R¹, R², and R³ in Formula (1), respectively.

L³ represents a single bond or a divalent linking group selected from the group consisting of —O—, —CO—, —NR⁴—, —S—, an alkylene group, and a combination thereof.

Examples of a suitable aspect of the combination of groups represented by L³ (the above described combination thereof) include the groups exemplified in the suitable aspect of the combination of groups represented by L².

R⁴ represents a hydrogen atom or an alkyl group.

The molecular weight of the compound represented by Formula (1) is not particularly limited, but is preferably 200 or more and less than 350, more preferably 200 or more and less than 300, and even more preferably 200 or more and less than 250 from the viewpoint that the effect of the present invention is more excellent.

The compound represented by Formula (1) is exemplified as follows.

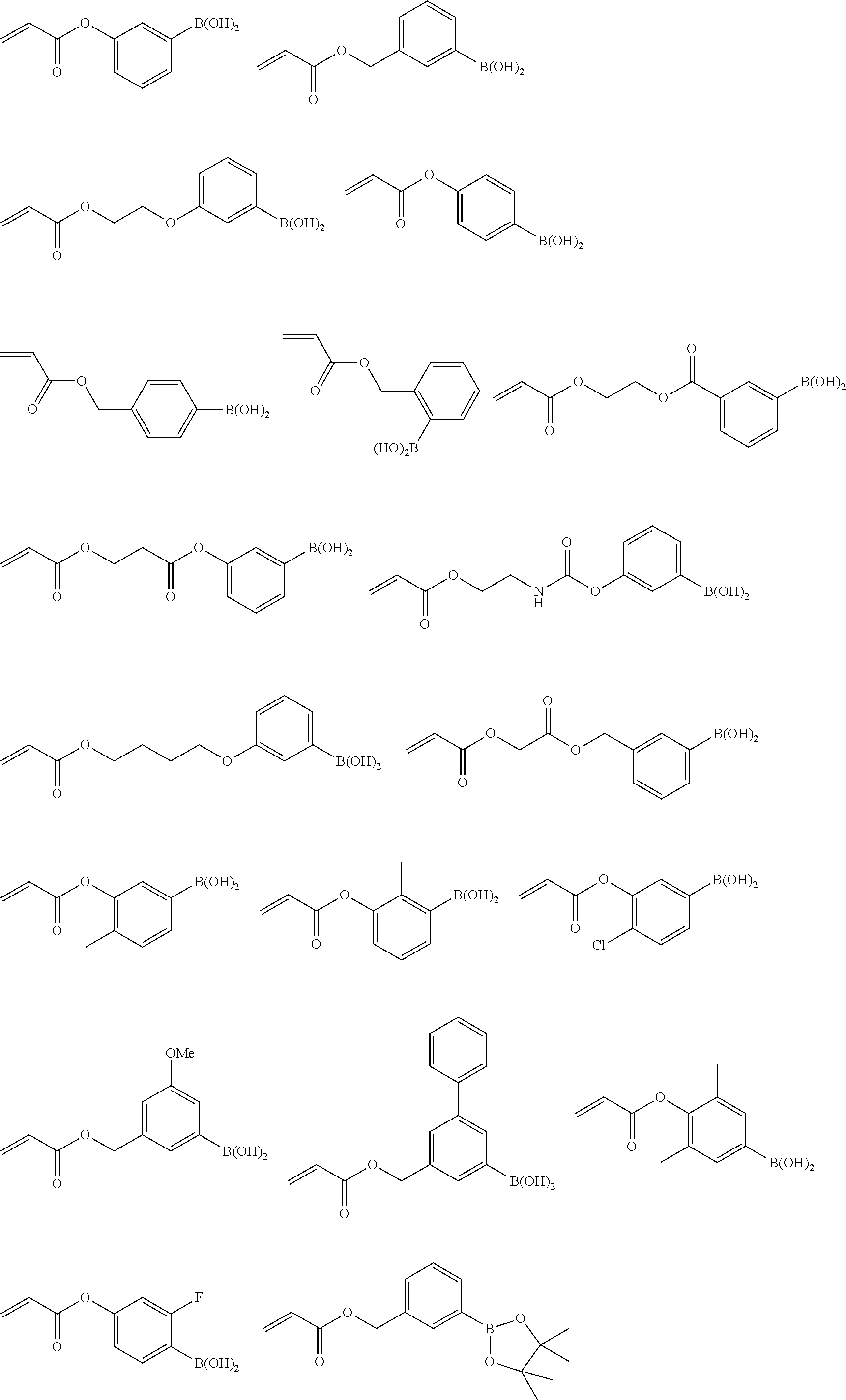

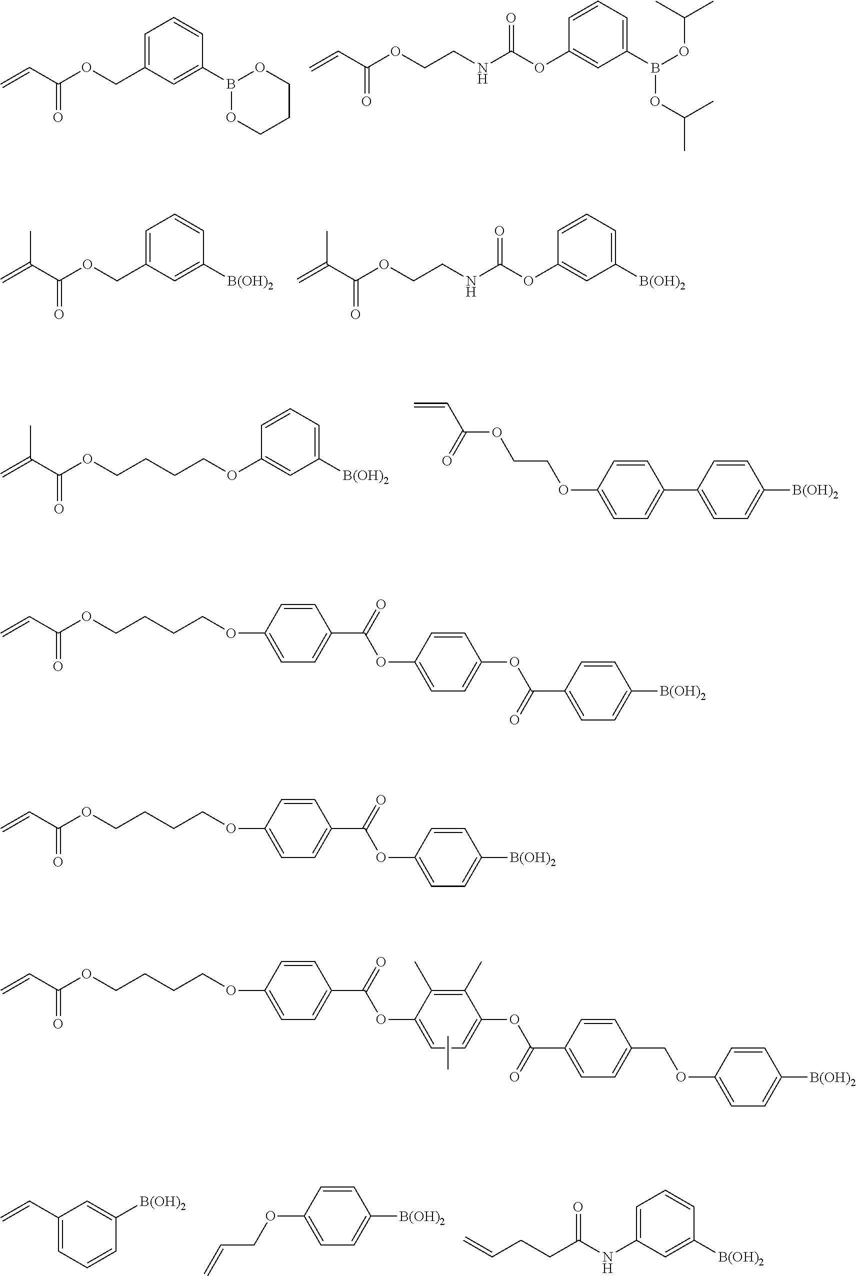

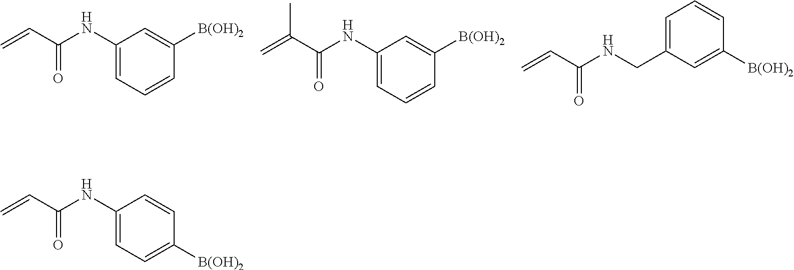

A content of the compound represented by Formula (1) in the composition is not particularly limited, but is often 0.1 to 10 parts by mass with respect to 100 parts by mass of the polymerizable liquid crystal compound, and from the viewpoint that the effect of the present invention is more excellent and the haze of the laminated glass is further suppressed, the content is preferably 0.30 to 6.0 parts by mass, and more preferably 1.0 to 2.5 parts by mass.

(Other Component)

The composition may contain the polymerizable liquid crystal compound and a compound other than the compound represented by Formula (1).

For example, the composition may contain a polymerization initiator. Examples of the polymerization initiator include a thermal polymerization initiator and a photopolymerization initiator. As the polymerization initiator, an acylphosphine oxide compound or an oxime compound is preferable.

The polymerization initiator may be used singly or in combination of two or more kinds thereof.

A content of the polymerization initiator in the composition is preferably 0.1% to 20% by mass and more preferably 0,5% to 5% by mass with respect to the content of the polymerizable liquid crystal compound.

The composition may include an alignment control agent.

Examples of the alignment control agent include a fluorine (meth)acrylate-based polymer disclosed in paragraphs 0018 to 0043 of JP2007-272185A, a compound represented by Formulae (I) to (IV) disclosed in paragraphs 0031 to 0034 of JP2012-203237, a compound disclosed in JP2013-113913A, and the like.

The alignment control agent may be used singly or in combination of two or more kinds thereof.

A content of the alignment control agent in the composition is preferably 0.01% to 10% by mass and more preferably 0.01% to 5% by mass with respect to the total mass of the polymerizable liquid crystal compound.

The composition may include a solvent. Examples of the solvent include water and organic solvents.

Examples of the organic solvent include ketones, alkyl halides, amides, sulfoxides, heterocyclic compounds, hydrocarbons, esters, and ethers.

A method of forming a retardation layer is not particularly limited, and a known method can be adopted.

For example, a method of applying a composition to a surface of an alignment layer, allowing a polymerizable liquid crystal compound in the composition to be aligned, and then performing immobilization by curing to form a retardation layer can be mentioned.

In a case where the polymerizable liquid crystal compound is aligned after the composition is applied, it is preferable to carry out a heat treatment, and the heating temperature is preferably 30° C. to 120° C. and more preferably 40° C. to 100° C.

A thickness of the retardation layer is not particularly limited, and is preferably 0.2 to 10 μm, more preferably 0.4 to 5.0 μm, and even more preferably 0.6 to 2.0 μm.

The slow axial direction of the retardation layer is preferably determined in accordance with the direction of incidence of the incident light for displaying a projection image and a sense of a helix of the cholesteric liquid crystal layer when used as a HUD system.

For example, in a case where the direction during the use in the HUD system is determined, the direction of the incident light is the lower direction (the lower vertical direction) of the laminated glass, and the light is incident on the cholesteric liquid crystal layer from the retardation layer side, the slow axial direction can be determined in the following range in accordance with the front retardation.

In a case where a retardation layer having a front retardation of 250 to 450 nm is used, it is preferable that the slow axis of the retardation layer is in a range of +30° to +85° or −30° to −85° with respect to the upper vertical direction of the laminated glass; and in a case where a retardation layer having a front retardation of 50 to 180 nm is used, it is preferable that the slow axis of the retardation layer is in a range of +120° to +175° or −120° to −175° with respect to the upper vertical direction of the laminated glass.

In addition, in the present specification, in a case where the term “upper vertical” is mentioned regarding the laminated glass, it means an upper vertical direction capable of being specified at the time of use.

Furthermore, the following configuration is preferable: in a case where a retardation layer having a front retardation of 250 to 450 nm is used, it is preferable that the slow axis of the retardation layer is in a range of +35° to +70° or −35° to −70° with respect to the upper vertical direction of the laminated glass; and, in a case where a retardation layer having a front retardation of 50 to 180 nm is used, it is preferable that the slow axis of the retardation layer is in a range of +125° to +160° or −125° to −160° with respect to the upper vertical direction of the laminated glass.

Regarding the slow axis, + and − are defined in the above, and + and − mean a clockwise direction (+) and a counterclockwise direction (−), respectively, in a case where a visible position is fixed, and the incident light is visually recognized from the incident side in the above.

The preferred direction depends on the sense of the helix of the cholesteric liquid crystal layer.

For example, in a case where a retardation layer having a front retardation of 250 to 450 nm is used and the sense of the helix of the cholesteric liquid crystal layer in the laminated glass is right, the slow axial direction is preferably a clockwise direction of 30° to 85° with respect to the cholesteric liquid crystal layer as viewed from the retardation layer side, and in a case where a retardation layer having a front retardation of 250 to 180 nm is used and the sense of the helix of the cholesteric liquid crystal layer in the laminated glass is right, the slow axial direction is preferably a clockwise direction of 120° to 175° with respect to the cholesteric liquid crystal layer as viewed from the retardation layer side.

In addition, in a case where a retardation layer having a front retardation of 250 to 450 nm is used and the sense of the helix of the cholesteric liquid crystal layer in the laminated glass is left, the slow axial direction is preferably a counterclockwise direction of 30° to 85° (−30° to −85°) with respect to the cholesteric liquid crystal layer as viewed from the retardation layer side, and in a case where a retardation layer having a front retardation of 250 to 180 nm is used and the sense of the helix of the cholesteric liquid crystal layer in the laminated glass is left, the slow axial direction is preferably a counterclockwise direction of 120° to 175° (−120° to −175°) with respect to the cholesteric liquid crystal layer as viewed from the retardation layer side.

<Cholesteric Liquid Crystal Layer>

The laminated glass according to the embodiment of the present invention includes a cholesteric liquid crystal layer.

The cholesteric liquid crystal layer means a layer obtained by a cholesteric liquid crystalline phase being immobilized.

The cholesteric liquid crystal layer may be any layer as long as the alignment of a liquid crystal compound serving as a cholesteric liquid crystalline phase is maintained. For example, the cholesteric liquid crystal layer is preferably a layer obtained in such a manner that a polymerizable liquid crystal compound is set in an aligned state of the cholesteric liquid crystalline phase, polymerized by ultraviolet irradiation or heating, and cured. The cholesteric, liquid crystal layer is preferably a layer that has no fluidity and is changed to be in a state in which the alignment form is not changed by an external field or an external force.

In the cholesteric liquid crystal layer, it is sufficient that optical properties of the cholesteric liquid crystalline phase are maintained in the layer, and the liquid crystal compound in the layer may not exhibit liquid crystal properties any more. For example, the polymerizable liquid crystal compound may have high molecular weight due to a curing reaction and may no longer have liquid crystal properties.

The cholesteric liquid crystal layer exhibits circularly polarized light selective reflection that selectively reflects circularly polarized light of any one sense of dextrorotatory circularly polarized light or levorotatory circularly polarized light, and transmits circularly polarized light of the other sense.

A selective reflection center wavelength λ (selective reflection center wavelength) of the cholesteric liquid crystal layer depends on a pitch P (=helix period) of a helical structure in the cholesteric phase, and is based on a relationship between an average refractive index n of the cholesteric liquid crystal layer and λ=n×P. It can be seen from the expression, the selective reflection center wavelength can be adjusted to the predetermined range by an n value and a P value being adjusted.

The selective reflection center wavelength and a half-value width of the cholesteric liquid crystal layer can be obtained as follows.

In a case where a transmission spectrum (measured from the normal direction of the cholesteric liquid crystal layer) of the cholesteric liquid crystal layer is measured using the spectrophotometer UV3150 (manufactured by Shimadzu Corporation), a reduction of peak of transmittance is observed in a selective reflection band. Among two wavelengths of intermediate (average) transmittance between a minimum transmittance of the peak and a transmittance before the peak of transmittance is reduced, in a case where a wavelength value of a shorter wavelength side is denoted by λₗ (nm) and a wavelength value of a longer wavelength side is denoted by λₕ (nm), the selective reflection center wavelength λ and a half-value width Δλ can be expressed by the following expression.

λ=(λₗ+λₕ)/2

Δλ=(λₕ−λₗ)

The selective reflection center wavelength obtained as described above substantially coincides with a wavelength at a centroid position of reflection peak of circularly polarized light reflection spectra measured in the normal direction of the cholesteric liquid crystal layer.

A range of the selective reflection center wavelength of the cholesteric liquid crystal layer is not particularly limited, but is preferably 650 to 780 nm. In the present specification, the selective reflection center wavelength λ of the cholesteric liquid crystal layer means a wavelength at a centroid position of a reflection peak in the reflection spectrum measured from the normal direction of the cholesteric liquid crystal layer.

In the HUD system, the reflectivity at the surface side of a glass plate on which the projection light is incident can be decreased by the light being obliquely incident on a laminated glass. In this case, the light is also obliquely incident on the cholesteric liquid crystal layer.

For example, light incident at an angle of 45° to 70° with respect to the normal line of the projection image display portion in air having the refractive index of 1 is transmitted through the cholesteric liquid crystal layer having the refractive index of about 1.61 at an angle of about 26° to 36°. In this case, the reflection wavelength shifts to the shorter wavelength side. Assuming that the selective reflection center wavelength is λ_{d} in a case where a ray of light passes at an angle of θ₂ with respect to the normal direction of the cholesteric liquid crystal layer (a helix axis direction of the cholesteric liquid crystal layer) in the cholesteric liquid crystal layer in which the selective reflection center wavelength is λ, λ_{d} is represented by the following expression.

λ_{d}=λ+cos θ₂

Therefore, the cholesteric liquid crystal layer having a selective reflection center wavelength in a range of 650 to 780 nm at an angle θ₂ of 26° to 36° can reflect projection light in a range of 520 to 695 nm.

Such a wavelength range is a wavelength range with high luminosity factor and thus highly contributes to the brightness of the projection image, and as a result, a projection image with high brightness can be realized.

The pitch of the cholesteric liquid crystalline phase depends on the type of chiral agents used together with the polymerizable liquid crystal compound and the addition concentration thereof, and thus, a desired pitch can be obtained by adjusting these. As a method of measuring the sense of helix and pitch, the methods described in “Introduction to Experimental Liquid Crystal Chemistry”, edited by The Japanese Liquid Crystal Society, published in 2007 by Sigma Publishing Co., Ltd., p. 46, and “Liquid Crystal Handbook”, the Editing Committee of Liquid Crystal Handbook, Maruzen Publishing Co., Ltd., p. 196 can be used.

The laminated glass according to the embodiment of the present invention may include only one cholesteric liquid crystal layer, or may include two or more layers.

The selective reflection center wavelengths of two or more cholesteric liquid crystal layers may be the same as or different from each other, but are preferably different from each other. The laminated glass includes two or more cholesteric liquid crystal layers having different selective reflection center wavelengths, so that double images can be reduced.

In a case where the two cholesteric liquid crystal layers are included, each selective reflection center wavelength of these two cholesteric liquid crystal layers is preferably different by 60 nm or more, more preferably different by 80 nm or more, and even more preferably different by 100 nm or more.

Both selective reflection center wavelengths of the two or more cholesteric liquid crystal layers may be 650 to 780 nm, at least one may be 650 to 780 nm, the other may be at a wavelength more than 780 nm, but both selective reflection center wavelengths are preferably 650 to 780 nm.

Examples of another suitable aspect also include an aspect using at least one of a cholesteric liquid crystal layer 1 having a selective reflection center wavelength at 450 to 570 nm, a cholesteric liquid crystal layer 2 having a selective reflection center wavelength at 580 to 680 nm, or a cholesteric liquid crystal layer 3 having a selective reflection center wavelength at 700 to 830 nm.

For example, the laminated glass according to the embodiment of the present invention may include only the cholesteric liquid crystal layer 3, may include only the cholesteric liquid crystal layer 2, or may include only the cholesteric liquid crystal layer 1.

The laminated glass according to the embodiment of the present invention may include the cholesteric liquid crystal layer 3, the cholesteric liquid crystal layer 2, and the cholesteric liquid crystal layer 1.

The laminated glass according to the embodiment of the present invention may include the cholesteric liquid crystal layer 3 and the cholesteric liquid crystal layer 2.

The laminated glass according to the embodiment of the present invention may include the cholesteric liquid crystal layer 3 and the cholesteric liquid crystal layer 1.

The laminated glass according to the embodiment of the present invention may include the cholesteric liquid crystal layer 2 and the cholesteric liquid crystal layer 1.

In the laminated glass of the embodiment of the present invention, the cholesteric liquid crystal layers are preferably disposed in order from the shortest selective reflection center wavelength as viewed from a visible side (inside a vehicle).

As each cholesteric liquid crystal layer, a cholesteric liquid crystal layer having tine sense of helix of right or left is used. A sense of reflective circularly polarized light in the cholesteric liquid crystal layer coincides with a sense of helix. All of the senses of helixes of the cholesteric liquid crystal layers having different selective reflection center wavelengths may be the same as or different from each other, but are preferably the same as each other.

In addition, a cholesteric liquid crystal layer that exhibits selective reflection in the same or overlapping wavelength range and has different sense of helix is preferably not included in the laminated glass according to the embodiment of the present invention.

In a case of laminating a plurality of the cholesteric liquid crystal layers, the cholesteric liquid crystal layers separately produced may be laminated by using an adhesive and the like, or the cholesteric liquid crystal layers may be formed by a step of directly applying a liquid crystal composition containing a polymerizable liquid crystal compound and the like to the surface of the cholesteric liquid crystal layer to perform alignment and immobilization being repeated.

A thickness of the cholesteric liquid crystal layer is not particularly limited, but is preferably 0.05 to 10 μm, more preferably 0.1 to 8.0 μm, and even more preferably 0.2 to 6.0 μm.

In a case where the laminated glass according to the embodiment of the present invention includes the plurality of the cholesteric liquid crystal layers, the total thickness of the cholesteric liquid crystal layers is preferably 2.0 to 30 μm, more preferably 2.5 to 25 μm, and even more preferably 3.0 to 20 μm.

The method of producing a cholesteric liquid crystal layer is not particularly limited, and known methods can be mentioned.

Examples thereof include a method of forming a cholesteric liquid crystal layer, in which cholesteric regularity is immobilized, by applying a polymerizable liquid crystal composition obtained in such a manner that a polymerizable liquid crystal compound, a chiral agent, a polymerization initiator that is added as necessary, a surfactant, and the like are dissolved in a solvent to a retardation layer or a cholesteric liquid crystal layer that is produced in advance, drying the polymerizable liquid crystal composition to obtain a coating film, heating this coating film to form a cholesteric liquid crystalline phase, and irradiating the cholesteric liquid crystalline phase with an actinic ray to be polymerized.

During the formation of the plurality of the cholesteric liquid crystal layers, the cholesteric liquid crystal layers can be formed by the above manufacturing steps being repeated.

The method of producing a cholesteric liquid crystal layer is described in detail in the publicly known document such as WO2016/052367A.

<Intermediate Film>

The laminated glass according to the embodiment of the present invention may include an intermediate film. As described above, the intermediate film is an optional member.

In FIG. 1, the intermediate film is provided between the second glass plate and the cholesteric liquid crystal layer, but for example, in a case where the heat seal layer is not provided, the intermediate film may be provided between the first glass plate and the transparent support, and may be provided between the second glass plate and the cholesteric liquid crystal layer.

As the intermediate film, any known intermediate film used for a windshield glass of wheeled vehicles or the like may be used. For example, a resin film including a resin selected from the group consisting of polyvinylbutyral (PVB), an ethylene-vinyl acetate copolymer, and a chlorine containing resin can be used. The resin is preferably a main component of the intermediate film. The main component means a component occupying a percentage of 50% by mass or more with respect to the total mass of the intermediate film.

Among these resins, polyvinyl butyral or an ethylene-vinyl acetate copolymer is preferable, and polyvinyl butyral is more preferable.

Polyvinyl butyral can be obtained by acetalizing polyvinyl alcohol with butyl aldehyde. The degree of acetalization of polyvinyl butyral is preferably 40% to 85%, and more preferably 60% to 75%.

A known bonding method can be used to bond the cholesteric liquid crystal layer and the intermediate film, and a laminate treatment is preferably used.

A temperature condition of the laminate treatment is not particularly limited, and a film surface temperature of the intermediate film side to be bonded is preferably 50° C. to 130° C. and more preferably −70° C. to 100° C.

The pressurization is preferably performed during the laminating. The pressurizing condition is not limited, but is preferably less than 2.0 kg/cm² (less than 196 kPa), and more preferably within a range of 0,5 to 1.8 kg/cm² (49 kPa to 176 kPa).

<Other Layers>

The laminated glass according to the embodiment of the present invention may include layers other than the above described each layer.

For example, the laminated glass according to the embodiment of the present invention may have an adhesive layer (for example, a pressure-sensitive adhesive layer and an adhesive layer) in order to ensure the adhesiveness of each layer.

<Manufacturing Method of Laminated Glass>

The method of manufacturing a laminated glass according to the embodiment of the present invention is not particularly limited, and examples thereof include the following method.

First, the alignment film and the retardation layer are formed on one surface of the transparent support in this order, and the cholesteric liquid crystal layer is formed on the retardation layer. Furthermore, the heat seal layer is formed on the opposite surface of the transparent support to obtain a predetermined laminate.

Next, the laminate is laminated in such a manner that the heat seal layer side on the obtained laminate faces the first glass plate.

Next, the intermediate film is laminated on a surface of the laminate (a surface of the cholesteric liquid crystal layer), and a second glass plate is laminated on the intermediate film.

In this way, the laminate including each member is produced, and the laminate is heated and pressed under reduced pressure to manufacture the laminated glass according to the embodiment of the present invention.

<Application>

The laminated glass according to the embodiment of the present invention is suitably used for a projection image display application. That is, the laminated glass according to the embodiment of the present invention is suitably used as a windshield glass having a projection image display function, such as a windshield glass constituting the HUD system.

In the present specification, the windshield glass generally means a window glass of wheeled vehicles such as cars and trains, and vehicles such as airplanes, ships, and play equipment. The windshield glass is preferably windshield glass in a traveling direction of the vehicles. The windshield glass is preferably windshield glass of wheeled vehicles.

The projection image display portion may be formed on the entire surface of the laminated glass or may be formed on a part with respect to the entire area of the laminated glass. In a case where the projection image display portion is partially formed, the projection image display portion may be provided at any position on the laminated glass, but for example, in a case of being used as the HUD system, the projection image display portion is preferably provided so that a virtual image is displayed at a position where the image can be easily visible from an observer (for example, a driver).

In the present specification, the projection image display portion is a portion that can display a projection image with reflected light, and may be a portion that can display a projection image projected from a projector in a visible manner.

<Projection Image Display System>

A projection image display system according to an embodiment of the present invention includes the laminated glass according to the embodiment of the present invention and a projector.

As the projector, various known projectors (image projection device (image projector) and projection device (projector)) can be used. Examples of the projector include a liquid crystal on silicon (LCOS) projector, a laser projector, a liquid crystal projector (liquid crystal display), a digital mirror device (DMD) projector, and a micro electro mechanical systems (MEMS) projector. Among these, a projector in which projection light is linearly polarized light is preferable.

In addition, the projection light projected from the projector is preferably p-polarized light.

The light incident from the projector to the laminated glass may be incident in any direction of upward, downward, rightward, and leftward of the laminated glass, and may be determined in accordance with a visible direction. For example, the projection light is preferably incident at an obliquely incident angle from the bottom during the use.

The projection image display system may be a projection system in which the virtual image forming position is variable. The projection system in which the virtual image forming position is variable is described in, for example, JP2009-150947A.

### EXAMPLES

The present invention will be described in more detail below based on Examples. The materials, the used amounts, the ratios, the treatment contents, and the treatment procedures described in the following Examples can be appropriately changed within the range that does not depart from the gist of the present invention. Therefore, the range of the present invention should not be limitatively interpreted by the following Examples.

### Example 1

(Cholesteric Liquid Crystal Layer-Forming Coating Liquids B and G)

The following components were mixed to prepare cholesteric liquid crystal layer-forming coating liquids B and G having the following composition.

Composition of Cholesteric Liquid Crystal Layer-Forming Coating Liquids B and G

| | |
|---|---|
| Mixture 1 | 100 parts by mass |
| Fluorine compound 1 | 0.05 parts by mass |
| Fluorine compound 2 | 0.04 parts by mass |
| Dextrorotatory chiral agent LC756 (manufactured by BASF SE) | adjusted in accordance with the target reflection wavelength |
| Polymerization initiator IRGACURE OXE01 (manufactured by BASF SE) | 1.0 part by mass |
| Solvent (methyl ethyl ketone | the amount of a solute concentration of 25% by mass |

Mixture 1 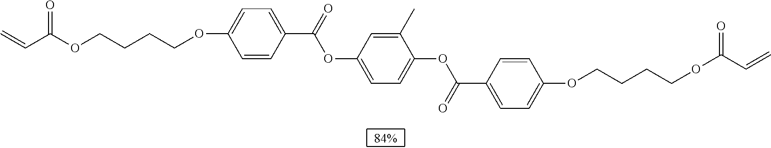 [SMILES: C=CC(=O)OCCCCOc1ccc(C(=O)Oc2ccc(OC(=O)c3ccc(OCCCCOC(=O)C=C)cc3)c(C)c2)cc1] 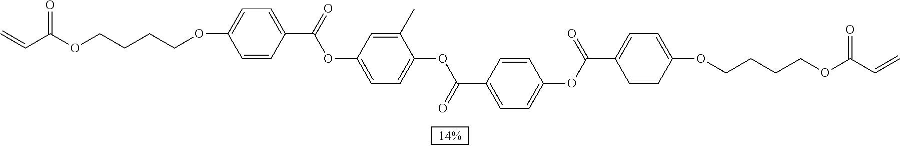 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1] 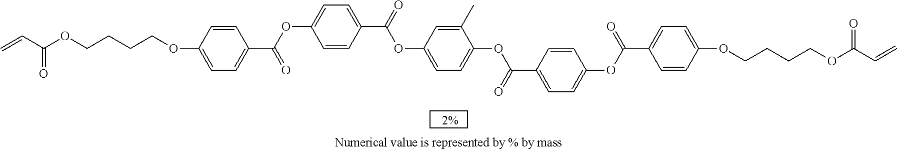 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
Fluorine compound 1 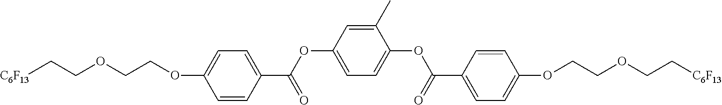
Fluorine compound 2

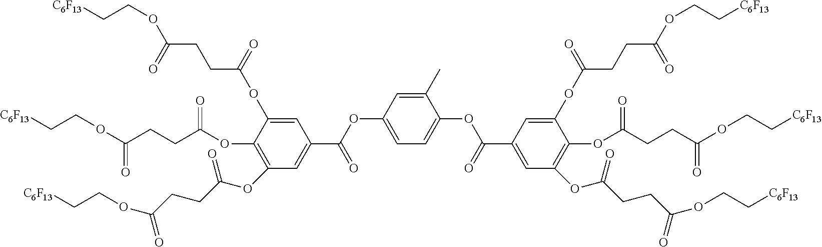

The prescription amount of the chiral agent LC756 was adjusted to prepare cholesteric liquid crystal layer-forming coating liquids B and G. Each cholesteric liquid crystal layer-forming coating liquid was used to produce a single layered cholesteric liquid crystal layer on a peelable support (a polyethylene terephthalate (PET) film (Cosmo Shine A4100, thickness of 100 μm) manufactured by TOYOBO CO., LTD.), and reflection characteristics were confirmed. As a result, all the produced cholesteric liquid crystal layers were dextrorotatory circularly polarized light reflection layers, a selective reflection center wavelength in a single liquid crystal layer of the cholesteric liquid crystal layer-forming coating liquid B was 465 nm, and a selective reflection center wavelength in a single liquid crystal layer of the cholesteric liquid crystal layer-forming coating liquid G was 710 nm.

(Cholesteric Liquid Crystal Layer-Forming Coating Liquid R)

The following components were mixed to prepare a cholesteric liquid crystal layer-forming coating liquid R having the following composition.

Composition of Cholesteric Liquid Crystal Layer-Forming Coating Liquid R

| | |
|---|---|
| Mixture 1 | 100 parts by mass |
| Fluorine compound 1 | 0.05 parts by mass |
| Fluorine compound 2 | 0.04 parts by mass |
| Copolymer 1 | 0.025 parts by mass |
| Dextrorotatory chiral agent LC756 (manufactured by BASF SE) | adjusted in accordance with the target reflection wavelength |
| Polymerization initiator IRGACURE OXE01 (manufactured by BASF SE) | 1.0 part by mass |
| Solvent (methyl ethyl ketone) | the amount of a solute concentration of 30% by mass |

Copolymer 1

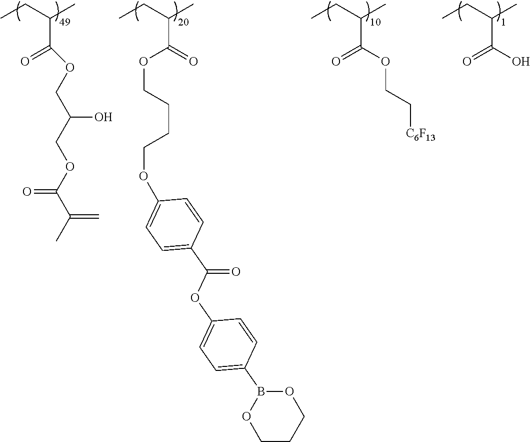

The prescription amount of the chiral agent LC756 was adjusted to prepare the cholesteric liquid crystal layer-forming coating liquid R. The cholesteric liquid crystal layer-forming coating liquid R was used to produce a single layered cholesteric liquid crystal layer on a peelable support (a PET film (Cosmo Shine A4100, thickness of 100 μm) manufactured by TOYOBO CO., LTD.), and reflection characteristics were confirmed. As a result, the produced cholesteric liquid crystal layers were a dextrorotatory circularly polarized light reflection layer, and a selective reflection center wavelength was 750 nm.

(Retardation Layer-forming Coating Liquid)

The following components were mixed to prepare a retardation layer-forming coating liquid having the following composition.

Composition of Retardation Layer-Forming Coating Liquid

| | |
|---|---|
| Mixture 1 | 100 parts by mass |
| Fluorine compound 1 | 0.05 parts by mass |
| Fluorine compound 2 | 0.01 parts by mass |
| Polymerization initiator IRGACURE | 0.75 parts by mass |
| OXE01 (manufactured by BASF SE) | |
| Compound 1 described later | 0.25 parts by mass |
| Solvent (methyl ethyl ketone) | the amount of a solute concen- |
| | tration of 25% by mass |

<Saponification of Cellulose Acylate Film>

A 40 μm cellulose acylate film obtained by the same production method as in Example 20 of WO2014/112575A was passed through a dielectric heating roll at a temperature of 60° C., and the temperature at a film surface was increased to 40° C. Thereafter, one side of the film was coated with an alkaline solution having the composition represented as follows at the coating amount of 14 ml/m² by using a bar coater and was allowed to stay under a steam-type far infrared heater (manufactured by NORITAKE CO., LIMITED) heated to 110° C. for 10 seconds.

Next, 3 ml/m² of pure water were applied to the obtained film by using a bar coater in the same manner.

Next, with respect to the obtained film, washing with a fountain coater and draining with an air knife were repeated three times, and then a cellulose acylate film 1 was produced by staying in a drying zone at 70° C. for 5 seconds, and being dried and saponification treated.

Composition of Alkaline Solution

| | |
|---|---|
| Potassium Hydroxide | 4.7 parts by mass |
| Water | 15.7 parts by mass |
| Isopropanol | 64.8 parts by mass |
| Surfactant | 1.0 part by mass |
| (C₁₆H₃₃O(CH₂CH₂O)₁₀H) | |
| Propylene glycol | 14.9 parts by mass |

<Formation of Alignment Film>

An alignment film-forming coating liquid having the composition shown below was applied on a saponified surface of the saponified cellulose acylate film 1 obtained above using a wire bar coater at 24 mL/m² and dried with warm air at 100° C. for 120 seconds to obtain a coating film.

Next, a rubbing treatment (rayon cloth, pressure of 0.1 kgf (0.98N), rotation speed of 1000 rpm, transport speed of 10 m/min, number of times of one reciprocation) was carried out on the produced coating film in a predetermined direction so as to achieve a slow axial direction of the retardation layer described later, and an alignment film was obtained.

Composition of Alignment Film-Forming Coating Liquid

| | | |
|---|---|---|
| Modified polyvinyl alcohol shown below | 28 | parts by mass |
| Citric acid ester (AS3, manufactured by Sankyo Chemical Co., Ltd.) | 1.2 | parts by mass |
| Photopolymerization initiator (IRGACURE 2959, manufactured by BASF SE) | 0.84 | parts by mass |
| Glutaraldehyde | 2.8 | parts by mass |
| Water | 699 | parts by mass |
| Methanol | 226 | parts by mass |

(Modified Polyvinyl Alcohol)

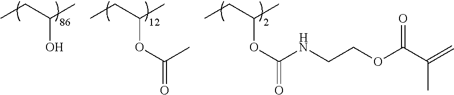

(Production of Retardation Layer and Cholesteric Liquid Crystal Layer)

A retardation layer-forming coating liquid was applied to an alignment film surface of the cellulose acylate film 1 using a wire bar, dried, and then heat-treated at 55° C. for one minute. Next, the obtained film was placed on a hot plate at 50° C. and irradiated with ultraviolet light for 6 seconds by an electrodeless lamp “D bulb” (60 mW/cm²) manufactured by Fusion UV Systems Japan K.K., and the liquid crystalline phase was immobilized to obtain a retardation layer having a thickness of 0.8 μm.

In this case, retardation of the phase difference layer and a slow axial angle were measured using AxoScan (manufactured by Axometrics, Inc), and as a result, in-plane retardation (front retardation) at a wavelength of 550 nm was 130 nm, and the slow axial angle was +135° with respect to the upper vertical direction of the completed laminated glass.

The cholesteric liquid crystal layer-forming coating liquid B was applied to a surface of the obtained retardation layer using a wire bar, dried, and heat-treated at 85° C. for one minute. The obtained film was placed on a hot plate at 80° C. and irradiated with UV for 6 seconds by an electrodeless lamp “D bulb” (60 mW/cm²) manufactured by Heraeus Co., Ltd., the cholesteric liquid crystalline phase was immobilized, and a cholesteric liquid crystal layer having a thickness of 2.3 μm was obtained.

The cholesteric liquid crystal layer-forming coating liquid G was applied to a surface of the obtained cholesteric liquid crystal layer using a wire bar, dried, and heat-treated at 70° C. for one minute. The obtained film was placed on a hot plate at 75° C. and irradiated with UV for 6 seconds by an electrodeless lamp “D bulb” (60 mW/cm²) manufactured by Heraeus Co., Ltd., the cholesteric liquid crystalline phase was immobilized, and a cholesteric liquid crystal layer having a thickness of 0.7 μm was obtained.

The cholesteric liquid crystal layer-forming coating liquid R was applied to a surface of the obtained cholesteric liquid crystal layer using a wire bar, dried, and heat-treated at 70° C. for one minute. The obtained film was placed on a hot plate at 75° C. and irradiated with UV for 6 seconds by an electrodeless lamp “D bulb” (60 mW/cm²) manufactured by Heraeus Co., Ltd., the cholesteric liquid crystalline phase was immobilized, and a cholesteric liquid crystal layer having a thickness of 2.8 μm was obtained.

In this way, a laminate A (half-mirror film) having a functional layer consisting of the retardation layer and the three cholesteric liquid crystal layers was obtained. A transmission spectrum of the laminate A was measured with a spectrophotometer (manufactured by JASCO Corporation, V-670), and as a result, transmission spectra having selective reflection center wavelengths at 465 nm, 710 nm, and 750 nm were obtained.

(Heat Seal Layer-Forming Coating Liquid)

The following components were mixed to prepare a heat seal layer-forming coating liquid having the following composition.

Heat Seal Layer-Forming Coating Liquid

| | |
|---|---|
| S LEC KS-10 (manufactured by | 4.75 parts by mass |
| Sekisui Chemical Co., Ltd.) | |
| Silica particle dispersion | 5.00 parts by mass |
| Methanol | 27.08 parts by mass |
| 1-Butanol | 1.43 parts by mass |
| Methyl ethyl ketone | 66.50 parts by mass |

A silica particle dispersion was produced by the following procedure.

AEROSIL 10000 (manufactured by Nippon Aerosil Co., Ltd.) was added to methyl isobutyl ketone so that the concentration of solid contents was 5% by mass, and the mixture was stirred with a magnetic stirrer for 30 minutes. Thereafter, the obtained solution was subjected to ultrasonic dispersion treatment with an ultrasonic disperser (Ultrasonic Homogenizer UH-600S manufactured by SMT Co., Ltd.) for 10 minutes to produce a silica particle dispersion.

A part of the obtained silica particle dispersion was collected for measuring the average secondary particle diameter, and the average secondary particle diameter of the silica particles in the dispersion was measured using Microtrac MT3000 (manufactured by MicrotracBEL Corp.), and as a result, the average secondary particle diameter was 190 nm.

(Production of Heat Seal Laminate)

The heat seal layer-forming coating liquid was applied to a rear surface of the laminate A (the surface side on which the cholesteric liquid crystal layer is not disposed) using a wire bar, and then dried and heat-treated at 100° C. for one minute to obtain a heat seal layer having a thickness of 1.0 μm.

According to this procedure, a heat seal laminate Ah including the heat seal layer, the retardation layer, the three cholesteric liquid crystal layers was obtained.

(Production of Laminated Glass)

The heat seal laminate Ah having a length of 200×a width of 200 mm were disposed on a center of a glass plate (first glass plate) having a length of 300 mm×a width of 300 mm×a thickness of 2 mm such that the heat seal layer side faces downward. That is, the transparent support, the retardation layer, and the cholesteric liquid crystal layer were disposed on the glass plate in this order. A PVB film (intermediate film) having a length of 300 mm×a width of 300 mm×a thickness of 0.76 mm manufactured by Sekisui Chemical Co., Ltd. is disposed on the cholesteric liquid crystal layer, and a glass plate (second glass plate) having a length of 300 mm×a width of 300 mm×a thickness of 2 mm was further disposed thereon.

The obtained laminate was held at 90° C. and 10 kPa (0.1 atm) for one hour, and then heated in an autoclave (manufactured by KURIHARA SEISAKUSHO Co., Ltd.) at 140° C. and 1.3 MPa (13 atm) for 20 minutes to remove air bubbles, and as a result, a laminated glass was obtained.

### Examples 2 to 14, and Comparative Examples 1 to 3

As shown in Table 1, laminated glasses were manufactured according to the same procedure as in Example 1, except that the kinds of boronic acid compounds and the added amounts (used amounts) were changed.

The transmission spectra of the laminated glasses obtained in Examples 1 to 14 and Comparative Examples 1 to 3 were measured with a spectrophotometer (manufactured by JASCO Corporation, V-670). As a result, a transmission spectrum having a selective reflection center wavelength at 465 nm, 710 nm, and 750 nm was obtained in each case.

<Evaluation>

The following evaluations were carried out using the laminated glasses obtained in Examples and Comparative Examples, respectively.

(Haze Evaluation)

In an environment of temperature 25° C. and humidity 60% RH, the laminated glass was measured according to JIS K-7136 (2000) using a haze meter (HGM-2DP, Suga tester), and evaluated according to the following references. The results are shown in Table 1. Among these, A, B, or C is preferable, A or B is more preferable, and A is even more preferable.

A: 0.30% or less

B: More than 0.30% and 0.40% or less

C: More than 0.40% and 0.50% or less

D: More than 0.50%

(Impact Resistance Evaluation by Ball Drop Test)

In order to evaluate the impact resistance, a ball drop test was conducted in accordance with JIS R 3211 and 3212. That is, a steel ball having a mass of 227±2 g and a diameter of about 38 mm was dropped at −20±2° C. from the height of 9 m onto the center portion of the laminated glass sample that has an area of about 300×300 mm and has been stored at a predetermined temperature for 4 hours or more, and the total mass (peeling amount) of the peeled debris from the opposite side of the impact surface was measured to perform the evaluation.

The smaller the peeling amount, the smaller the peeling amount and scattering amount of dangerous glass debris generated when the impact is applied to the laminated glass, which indicates that the laminated glass was safer for occupants in wheeled vehicles or the like. In JIS R 3211 and 3212, regarding each thickness of the laminated glass, the peeling allowance for passing the test was specified, but in the present invention, the evaluation was performed based on the relative peeling amount, and the results were used as a substitute evaluation for the impact resistance. The results are shown in Table 1.

In this method, an evaluation in a case where the glass peeling amount was less than 15 g was designated as A, an evaluation in a case where the glass peeling amount was 15 g or more and less than 30 g was designated as B, and an evaluation in a case where the glass peeling amount was 30 g or more was designated as C. A or B was preferable, and A is more preferable.

In Table 1, Compounds 1 to 6 and Comparative Compounds 1 and 2 in “Boronic acid compound” represent the following compounds, respectively.

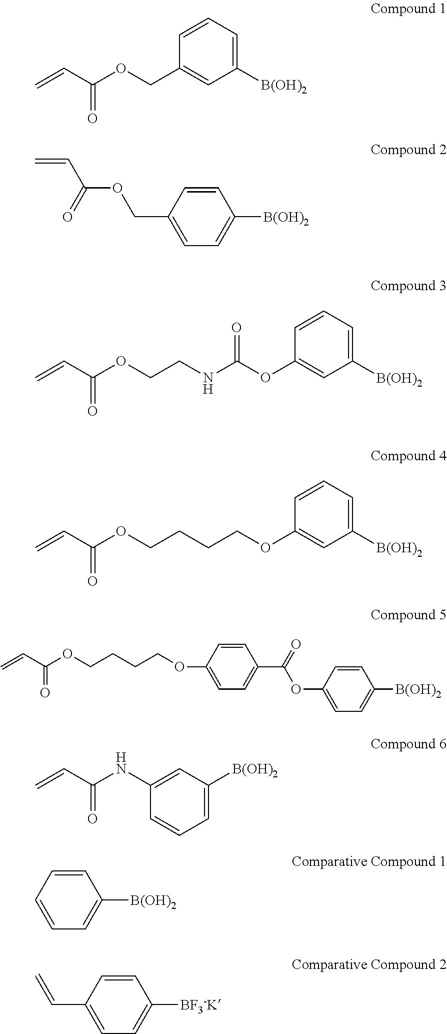

In Table 1, the “Linking group 1” column represents the kinds of the linking groups directly linked to the double bond in the boronic acid compound, and regarding Compounds 1 to 5, the “Ester group” is indicated since the ester group is linked to the double bond, and regarding Compound 6, the “Amide group” is indicated since the amide group is linked to the double bond.

In Table 1, the “Linking group 2” columns are designated by “A” in a case where “L²” in the compound represented by Formula (2) represents a single bond or a divalent linking group selected from the group consisting of —O—, —CO—, —S—, an alkylene group, and a combination thereof, and the other column is designated by “B” in other cases.

In Table 1, the “Meta-coordination” column represents the arrangement position of the “B(OH)₂” group in Compounds 1 to 6, and a case where the “B(OH)₂” group is arranged at the meta-coordination with respect to a group haying a double bond is designated by “A”, and the other case is designated by “B”.

In Table 1, the “Molecular weight” column represents the molecular weight of the boronic acid compound.

In Table 1, the “added amount” column represents the added amount of the boronic acid compound with respect to 100 parts by mass of the polymerizable liquid crystal compound.

TABLE 1

| | | | | | | Added | | |
|---|---|---|---|---|---|---|---|---|
| | | | | | | amount | | |
| | | | | | | (parts | | |
| | Boronic acid | Linking | Linking | Meta- | Molecular | by | | Impact |
| Table l | compound | group 1 | group 2 | coordination | weight | mass) | Haze | resistance |
| Example 1 | Compound 1 | Ester | A | A | 205 | 0.25 | A | B |
| | | group | | | | | | |
| Example 2 | Compound 1 | Ester | A | A | 205 | 0.5 | A | A |
| | | group | | | | | | |
| Example 3 | Compound 1 | Ester | A | A | 205 | 1.0 | A | A |
| | | group | | | | | | |
| Example 4 | Compound 1 | Ester | A | A | 205 | 2.5 | A | A |
| | | group | | | | | | |
| Example 5 | Compound 1 | Ester | A | A | 205 | 5.0 | A | A |
| | | group | | | | | | |
| Example 6 | Compound 1 | Ester | A | A | 205 | 7.5 | B | A |
| | | group | | | | | | |
| Example 7 | Compound 2 | Ester | A | B | 219 | 5.0 | B | A |
| | | group | | | | | | |
| Example 8 | Compound 3 | Ester | A | A | 278 | 1.0 | A | A |
| | | group | | | | | | |
| Example 9 | Compound 3 | Ester | A | A | 278 | 2.5 | A | A |
| | | group | | | | | | |
| Example 10 | Compound 4 | Ester | A | A | 263 | 1.0 | A | A |
| | | group | | | | | | |
| Example 11 | Compound 4 | Ester | A | A | 263 | 2.5 | A | A |
| | | group | | | | | | |
| Example 12 | Compound 4 | Ester | A | A | 263 | 5.0 | A | A |
| | | group | | | | | | |
| Example 13 | Compound 5 | Ester | B | B | 384 | 1.0 | C | A |
| | | group | | | | | | |
| Example 14 | Compound 6 | Amide | A | A | 180 | 2.5 | B | B |
| | | group | | | | | | |
| Comparative | None | — | — | — | — | — | A | C |
| Example 1 | | | | | | | | |
| Comparative | Comparative | — | — | — | — | 2.5 | B | C |
| Example 2 | Compound 1 | | | | — | | | |
| Comparative | Comparative | — | — | — | — | 2.5 | B | C |
| Example 3 | Compound 2 | | | | | | | |

As shown in Table 1, it was confirmed that the desired effect can be obtained by the laminated glass according to the embodiment of the present invention.

Among these, from the comparison of Examples 1 to 6, in a case where the added amount (content) of the boronic acid compound with respect to 100 parts by mass of the polymerizable liquid crystal compound is 0.30 to 6.0 parts by mass, it was confirmed that the effect is more excellent.

In addition, from the comparison of Examples 5, 7, and 12, it was confirmed that in a case where the boronic acid group is arranged at the meta-coordination (in a case of the compound represented by Formula (3)), the effect is more excellent.

In addition, from the comparison of Examples 4, 9, 11, and 14, it was confirmed that in a case where Linking group 1 is an ester group (in a case of the compound represented by Formula (2)), the effect is more excellent.

In addition, from the comparison of Examples 3, 8, 10, and 13, it was confirmed that in a case where “L²” in the compound represented by Formula (2) represents a single bond or a divalent linking group selected from the group consisting of —O—, —CO—, —NR⁴, —S—, an alkylene group, and a combination thereof, the effect is more excellent.

The laminated glass produced in each Example was used to produce a projection image display system (see FIG. 2). Specifically, as shown in FIG. 2, a projector and the laminated glass were disposed at predetermined positions, the projection image was emitted from the projector, and as a result, the observer was able to observe the image projected on the laminated glass.

### EXPLANATION OF REFERENCES

10 laminated glass

12 first glass plate

14 heat seal layer

16 transparent support.

18 alignment film

20 retardation layer

22 cholesteric liquid crystal layer

24 intermediate film

26 second glass plate

30 projector

What is claimed is:

1. A laminated glass comprising, in the following order:
a first glass plate;
an alignment film containing a vinyl alcohol resin;
a retardation layer formed of a composition containing a polymerizable liquid crystal compound and a compound represented by Formula (1);
a cholesteric liquid crystal layer; and
a second glass plate, 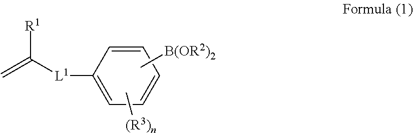
in Formula (1), R¹ represents a hydrogen atom or a methyl group,
L¹ represents a single bond or a divalent linking group,
R² represents a hydrogen atom, a substituted or unsubstituted alkyl group, a substituted or unsubstituted aryl group, or a substituted or unsubstituted heteroaryl group, two R²'s may be bonded to each other to form a ring,
R³ represents a substituent, and
n represents an integer of 0 to 4.

2. The laminated glass according to claim 1,
wherein the compound represented by Formula (1) is a compound represented by Formula (2), 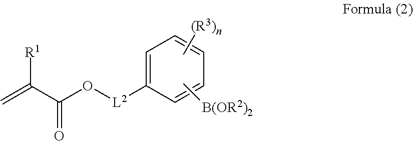
in Formula (2), R¹, R², and R³ are the same as R¹, R², and R³ in Formula (1) respectively,
L² represents a single bond or a divalent linking group selected from the group consisting of —O—, —CO—, —NR⁴—, —S—, are alkylene group, an arylene group, a heterocyclic group, and a combination thereof, and
R⁴ represents a hydrogen atom or an alkyl group.

3. The laminated glass according to claim 2,
wherein L² represents a single bond or a divalent linking group selected from the group consisting of —O—, —CO—, —NR⁴—, —S—, an alkylene group, and a combination thereof, and
R⁴ represents a hydrogen atom or an alkyl group.

4. The laminated glass according to claim 1,
wherein the compound represented by Formula (1) is a compound represented by Formula (3), 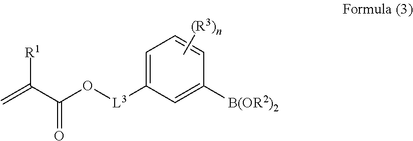
in Formula (3), R¹, R², and R³ are the same as R¹, R², and R³ in Formula (1), respectively,
L³ represents a single bond or a divalent linking group selected from the group consisting of —O—, —CO—, —NR⁴—, —S—, an alkylene group, and a combination thereof, and
R⁴ represents a hydrogen atom or an alkyl group.

5. The laminated glass according to claim 1,
wherein the compound has a molecular weight of 200 or more and less than 350.

6. The laminated glass according to claim 1,
wherein a content of the compound in the composition is 0.30 to 6.0 parts by mass with respect to 100 parts by mass of the polymerizable liquid crystal compound.

7. A projection image display system comprising:
the laminated glass according to claim 1; and
a projector.

8. The laminated glass according to claim 2,
wherein the compound represented by Formula (1) is a compound represented by Formula (3), 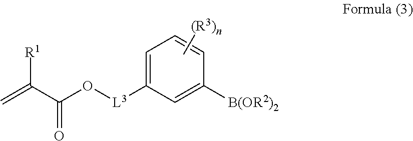
in Formula (3), R¹, R², and R³ are the same as R¹, R², and R³ in Formula (1), respectively,
L³ represents a single bond or a divalent linking group selected from the group consisting of —O—, —CO—, —NR⁴—, —S—, an alkylene group, and a combination thereof, and
R⁴ represents a hydrogen atom or an alkyl group.

9. The laminated glass according to claim 2,
wherein the compound has a molecular weight of 200 or more and less than 350.

10. The laminated glass according to claim 2,
wherein a content of the compound in the composition is 0.30 to 6.0 parts by mass with respect to 100 parts by mass of the polymerizable liquid crystal compound.

11. A projection image display system comprising:
the laminated glass according to claim 2; and
a projector.

12. The laminated glass according to claim 3,
wherein the compound represented by Formula (1) is a compound represented by Formula (3), 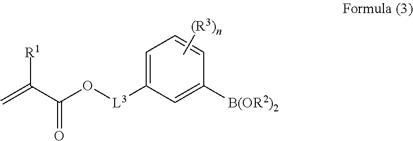
in Formula (3), R¹, R², and R³ are the same as R¹, R², and R³ in Formula (1), respectively,
L³ represents a single bond or a divalent linking group selected from the group consisting of —O—, —CO—, —NR⁴13 , —S—, an alkylene group, and a combination thereof, and
R⁴ represents a hydrogen atom or an alkyl group.

13. The laminated glass according to claim 3,
wherein the compound has a molecular weight of 200 or more and less than 350.

14. The laminated glass according to claim 3,
wherein a content of the compound in the composition is 0.30 to 6.0 parts by mass with respect to 100 parts by mass of the polymerizable liquid crystal compound.

15. A projection image display system comprising:
the laminated glass according to claim 3; and
a projector.

16. The laminated glass according to claim 4,
wherein the compound has a molecular weight of 200 or more and less than 350.

17. The laminated glass according to claim 4,
wherein a content of the compound in the composition is 0.30 to 6.0 parts by mass with respect to 100 parts by mass of the polymerizable liquid crystal compound.

18. A projection image display system comprising:
the laminated glass according to claim 4; and
a projector.

19. The laminated glass according to claim 5,
wherein a content of the compound in the composition is 0.30 to 6.0 parts by mass with respect to 100 parts by mass of the polymerizable liquid crystal compound.

20. A projection image display system comprising:
the laminated glass according to claim 5; and
a projector.
